(19) United States
(12) Patent Application Publication
(10) Pub. No.: US 2016/0317977 A1
(43) Pub. Date: Nov. 3, 2016

(54) HIGHLY SWELLABLE COMPOSITE POLYAMIDE MEMBRANE

(71) Applicant: DOW GLOBAL TECHNOLOGIES LLC, Midland, MI (US)

(72) Inventors: Abhishek Roy, Edina, MN (US); Nicholas S. Beck, Minneapolis, MN (US); Robert C. Cieslinski, Midland, MI (US); Bruce B. Gerhart, Midland, MI (US); David D. Hawn, Midland, MI (US); Duane Jacobson, Minneapolis, MN (US); Mou Paul, Edina, MN (US); Carl W. Reinhardt, Kawkawlin, MI (US); Katmerka Tabakovic, Edina, MN (US); Ian A. Tomlinson, Midland, MI (US)

(21) Appl. No.: 15/104,023

(22) PCT Filed: Dec. 15, 2014
(86) PCT No.: PCT/US14/70343

§ 371 Date: Jun. 13, 2016

Related U.S. Application Data
(60) Provisional application No. 61/926,583, filed on Jan. 13, 2014.

(51) Int. Cl. B01D 69/12; B01D 67/00; B01D 71/56

(52) U.S. Cl. CPC B01D 69/125; B01D 71/56; B01D 67/0006; B01D 2323/40

(57) ABSTRACT

A method for making a composite polyamide membrane including the step of applying a polar solution including a polyfunctional amine monomer and a non-polar solution comprising a polyfunctional acyl halide monomer to a surface of a porous support and interfacially polymerizing the monomers to form a thin film polyamide layer, wherein the method is characterized by including a tri-hydrocarbyl phosphate within the polar coating solution. The thin film polyamide layer is characterized by possessing an equilibrium water swelling factor of greater than 35% as measured by PFT-AFM.

### FIELD

The invention is generally directed toward composite polyamide membranes along with methods for making and using the same.

### INTRODUCTION

Composite polyamide membranes are used in a variety of fluid separations. One common class of membranes includes a porous support coated with a “thin film” polyamide layer. This class of membrane is commonly referred to as thin film composite (TFC). The thin film layer may be formed by an interfacial polycondensation reaction between polyfunctional amine (e.g. m-phenylenediamine) and polyfunctional acyl halide (e.g. trimesoyl chloride) monomers which are sequentially coated upon the support from immiscible solutions, see for example U.S. Pat. No. 4,277,344 to Cadotte. US2013/0287946, US2013/0287944, US2013/0287945, US2014/0170314, WO2013/048765 and WO2013/103666 further describe the addition of various monomers including carboxylic acid and amine-reactive functional groups in combination with the addition of a tri-hydrocarbyl phosphate compound as described in U.S. Pat. No. 6,878,278 to Mickols. The search continues for new combinations of monomers and additives that further improve composite polyamide membrane performance.

### SUMMARY

The invention includes a method for making a composite polyamide membrane including the step of applying a polar solution including a polyfunctional amine monomer and a non-polar solution comprising a polyfunctional acyl halide monomer to a surface of a porous support and interfacially polymerizing the monomers to form a thin film polyamide layer. The method is characterized by including a tri-hydrocarbyl phosphate within the polar coating solution. The thin film polyamide layer is characterized by possessing an equilibrium water swelling factor of greater than 35% as measured by PFT-AFM. Swelling of the thin film polyamide layer affects both flux and salt passage and is a measure of the polymer network structure of the polyamide layer. Many embodiments are described including applications for such membranes.

### BRIEF DESCRIPTION OF THE DRAWINGS

FIG. 1 is a plot of a MS response (a) for a representative thin film polyamide layer as a function of temperature (b) corresponding to a representative thin film polyamide layer.

### DETAILED DESCRIPTION

The invention is not particularly limited to a specific type, construction or shape of composite membrane or application. For example, the present invention is applicable to flat sheet, tubular and hollow fiber polyamide membranes useful in a variety of applications including forward osmosis (FO), reverse osmosis (RO), nano filtration (NF), ultra filtration (UF), micro filtration (MF) and pressure retarded fluid separations. However, the invention is particularly useful for membranes designed for RO and NF separations. RO composite membranes are relatively impermeable to virtually all dissolved salts and typically reject more than about 95% of salts having monovalent ions such as sodium chloride. RO composite membranes also typically reject more than about 95% of inorganic compounds as well as organic molecules with molecular weights greater than approximately 100 Daltons. NF composite membranes are more permeable than RO composite membranes and typically reject less than about 95% of salts having monovalent ions while rejecting more than about 50% (and often more than 90%) of salts having divalent ions—depending upon the species of divalent ion. NF composite membranes also typically reject particles in the nanometer range as well as organic molecules having molecular weights greater than approximately 200 to 500 Daltons (AMU).

Examples of composite polyamide membranes include a flat sheet composite membrane comprising a bottom layer (back side) of a nonwoven backing web (e.g. PET scrim), a middle layer of a porous support having a typical thickness of about 25-125 μm and top layer (front side) comprising a thin film polyamide layer having a thickness typically less than about 1 micron, e.g. from 0.01 micron to 1 micron but more commonly from about 0.01 to 0.1 μm. The porous support is typically a polymeric material having pore sizes which are of sufficient size to permit essentially unrestricted passage of permeate but not large enough so as to interfere with the bridging over of a thin film polyamide layer formed thereon. For example, the pore size of the support preferably ranges from about 0.001 to 0.5 μm. Non-limiting examples of porous supports include those made of: polysulfone, polyether sulfone, polyimide, polyamide, polyetherimide, polyacrylonitrile, poly(methyl methacrylate), polyethylene, polypropylene, and various halogenated polymers such as polyvinylidene fluoride. For RO and NF applications, the porous support provides strength but offers little resistance to fluid flow due to its relatively high porosity.

Due to its relative thinness, the polyamide layer is often described in terms of its coating coverage or loading upon the porous support, e.g. from about 2 to 5000 mg of polyamide per square meter surface area of porous support and more preferably from about 50 to 500 mg/m². The polyamide layer is preferably prepared by an interfacial polycondensation reaction between a polyfunctional amine monomer and a polyfunctional acyl halide monomer upon the surface of the porous support as described in U.S. Pat. No. 4,277,344 and U.S. Pat. No. 6,878,278. More specifically, the polyamide membrane layer may be prepared by interfacially polymerizing a polyfunctional amine monomer with a polyfunctional acyl halide monomer, (wherein each term is intended to refer both to the use of a single species or multiple species), on at least one surface of a porous support. As used herein, the term “polyamide” refers to a polymer in which amide linkages (—C(O)NH—) occur along the molecular chain. The polyfunctional amine and polyfunctional acyl halide monomers are most commonly applied to the porous support by way of a coating step from solution, wherein the polyfunctional amine monomer is typically coated from an aqueous-based or polar solution and the polyfunctional acyl halide from an organic-based or non-polar solution. Although the coating steps need not follow a specific order, the polyfunctional amine monomer is preferably first coated on the porous support followed by the polyfunctional acyl halide. Coating can be accomplished by spraying, film coating, rolling, or through the use of a dip tank among other coating techniques. Excess solution may be removed from the support by air knife, dryers, ovens and the like.

The polyfunctional amine monomer comprises at least two primary amine groups and may be aromatic (e.g., m-phenylenediamine (mPD), p-phenylenediamine, 1,3,5-triaminobenzene, 1,3,4-triaminobenzene, 3,5-diaminobenzoic acid, 2,4-diaminotoluene, 2,4-diaminoanisole, and xylylenediamine) or aliphatic (e.g., ethylenediamine, propylenediamine, cyclohexane-1,3-diameine and tris (2-diaminoethyl) amine). One particularly preferred polyfunctional amine is m-phenylene diamine (mPD). The polyfunctional amine monomer may be applied to the porous support as a polar solution (e.g. acqueous). The polar solution may contain from about 0.1 to about 10 wt % and more preferably from about 1 to about 6 wt % polyfunctional amine monomer. In one set of embodiments, the polar solutions includes at least 2.5 wt % (e.g. 2.5 to 6 wt %) of the polyfunctional amine monomer. Once coated on the porous support, excess solution may be removed.

The polyfunctional acyl halide monomer comprises at least two acyl halide groups and preferably no carboxylic acid functional groups and may be coated from a non-polar solvent although the polyfunctional acyl halide may be alternatively delivered from a vapor phase (e.g., for polyfunctional acyl halides having sufficient vapor pressure). The polyfunctional acyl halide is not particularly limited and aromatic or alicyclic polyfunctional acyl halides can be used along with combinations thereof. Non-limiting examples of aromatic polyfunctional acyl halides include: trimesic acyl chloride, terephthalic acyl chloride, isophthalic acyl chloride, biphenyl dicarboxylic acyl chloride, and naphthalene dicarboxylic acid dichloride. Non-limiting examples of alicyclic polyfunctional acyl halides include: cyclopropane tri carboxylic acyl chloride, cyclobutane tetra carboxylic acyl chloride, cyclopentane tri carboxylic acyl chloride, cyclopentane tetra carboxylic acyl chloride, cyclohexane tri carboxylic acyl chloride, tetrahydrofuran tetra carboxylic acyl chloride, cyclopentane dicarboxylic acyl chloride, cyclobutane dicarboxylic acyl chloride, cyclohexane dicarboxylic acyl chloride, and tetrahydrofuran dicarboxylic acyl chloride. One preferred polyfunctional acyl halide is trimesoyl chloride (TMC). The polyfunctional acyl halide may be dissolved in a non-polar solvent in a range from about 0.01 to 10 wt %, preferably 0.05 to 3 % wt % and may be delivered as part of a continuous coating operation. In one set of embodiments wherein the polyfunctional amine monomer concentration is less than 3 wt %, the polyfunctional acyl halide is less than 0.3 wt %. Suitable solvents are those which are capable of dissolving the polyfunctional acyl halide and which are immiscible with water; e.g. paraffins (e.g. hexane, cyclohexane, heptane, octane, dodecane), isoparaffins (e.g. ISOPAR™ L), aromatics (e.g. Solvesso™ aromatic fluids, Varsol™ non-dearomatized fluids, benzene, alkylated benzene (e.g. toluene, xylene, trimethylbenzene isomers, diethylbenzene)) and halogenated hydrocarbons (e.g. FREON™ series, chlorobenzene, di and trichlorobenzene) or mixtures thereof. Preferred solvents include those which pose little threat to the ozone layer and which are sufficiently safe in terms of flashpoints and flammability to undergo routine processing without taking special precautions. A preferred solvent is ISOPAR™ available from Exxon Chemical Company. The non-polar solution may include additional constituents including co-solvents, phase transfer agents, solubilizing agents, complexing agents and acid scavengers wherein individual additives may serve multiple functions. Representative co-solvents include: benzene, toluene, xylene, mesitylene, ethyl benzene-diethylene glycol dimethyl ether, cyclohexanone, ethyl acetate, butyl carbitol™ acetate, methyl laurate and acetone. A representative acid scavenger includes N, N-diisopropylethylamine (DIEA). The non-polar solution may also include small quantities of water or other polar additives but preferably at a concentration below their solubility limit in the non-polar solution.

The polar solution additionally includes a tri-hydrocarbyl phosphate compound as represented by Formula I.

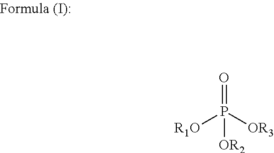

wherein “P” is phosphorous, “O” is oxygen and R₁, R₂ and R₃ are independently selected from hydrogen and hydrocarbyl groups comprising from 1 to 3 carbon atoms, with the proviso that no more than one of R₁, R₂ and R₃ are hydrogen. Applicable groups include both branched and unbranched species, e.g. methyl, ethyl, propyl and isopropyl. The aforementioned groups may be unsubstituted or substituted (e.g., substituted with methyl, ethyl, propyl, hydroxyl, amide, ether, sulfone, carbonyl, ester, cyanide, nitrile, isocyanate, urethane, beta-hydroxy ester, etc); however, unsubstituted alkyl groups having from 1 to 3 carbon atoms are preferred. Specific examples of tri-hydrocarbyl phosphate compounds include: trimethyl phosphate, triethyl phosphate tripropyl phosphate and tributyl phosphate. The specific compound selected should be at least partially soluble in the polar coating solution, e.g. at least 0.03 wt % in water at 25C, pH7. When combined within the polar solution, the solution preferably includes from 0.01 to 3 wt % and more preferably from 0.1 to 2 wt % of the tri-hydrocarbyl phosphate compound. A preferred species is triethylphosphate (TEP).

In a subset of embodiments, the non-polar phase may also include a tri-hydrocarbyl phosphate compound, includes those described in US2013/0287946, US2013/0287944, US2013/0287945 and U.S. Pat. No. 6,878,278—each of which is incorporated in its entirety.

In a subset of embodiments, the non-polar solution further comprises an acid-containing monomer comprising a C₂-C₂₀ hydrocarbon moiety substituted with at least one carboxylic acid functional group or salt thereof and at least one amine-reactive functional group selected from: acyl halide, sulfonyl halide and anhydride, wherein the acid-containing monomer is distinct from the polyfunctional acyl halide monomer. In one set of embodiments, the acid-containing monomer comprises an arene moiety. Non-limiting examples include mono and di-hydrolyzed counterparts of the aforementioned polyfunctional acyl halide monomers including two to three acyl halide groups and mono, di and tri-hydrolyzed counterparts of the polyfunctional halide monomers that include at least four amine-reactive moieties. A preferred species includes 3,5-bis(chlorocarbonyl)benzoic acid (i.e. mono-hydrolyzed trimesoyl chloride or “mhTMC”). Additional examples of monomers are described in US2013/0287946 and US2013/0287944 (see Formula III wherein the amine-reactive groups (“Z”) are selected from acyl halide, sulfonyl halide and anhydride). Specific species including an arene moiety and a single amine-reactive group include: 3-carboxylbenzoyl chloride, 4-carboxylbenzoyl chloride, 4-carboxy phthalic anhydride and 5-carboxy phthalic anhydride, and salts thereof. Additional examples are represented by Formula II.

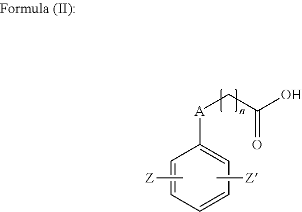

wherein A is selected from: oxygen (e.g. —O—); amino (—N(R)—) wherein R is selected from a hydrocarbon group having from 1 to 6 carbon atoms, e.g. aryl, cycloalkyl, alkyl—substituted or unsubstituted but preferably alkyl having from 1 to 3 carbon atoms with or without substituents such as halogen and carboxyl groups); amide (—C(O)N(R))— with either the carbon or nitrogen connected to the aromatic ring and wherein R is as previously defined; carbonyl (—C(O)—); sulfonyl (—SO₂—); or is not present (e.g. as represented in Formula III); n is an integer from 1 to 6, or the entire group is an aryl group; Z is an amine reactive functional group selected from: acyl halide, sulfonyl halide and anhydride (preferably acyl halide); Z′ is selected from the functional groups described by Z along with hydrogen and carboxylic acid. Z and Z′ may be independently positioned meta or ortho to the A substituent on the ring. In one set of embodiments, n is 1 or 2. In yet another set of embodiments, Z and Z′ are both the same (e.g. both acyl halide groups). In another set of embodiments, A is selected from alkyl and alkoxy groups having from 1 to 3 carbon atoms. Non-limiting representative species include: 2-(3,5-bis(chlorocarbonyl)phenoxy)acetic acid, 3-(3,5-bis(chlorocarbonyl)phenyl) propanoic acid, 2-((1,3-dioxo-1,3-dihydroisobenzofuran-5-yl)oxy)acetic acid, 3-(1,3-dioxo-1,3-dihydroisobenzofuran-5-yl)propanoic acid, 2-(3-(chlorocarbonyl) phenoxy)acetic acid, 3-(3-(chlorocarbonyl)phenyl)propanoic acid, 3-((3,5bis(chlorocarbonyl)phenyl) sulfonyl) propanoic acid, 3-((3-(chlorocarbonyl)phenyl)sulfonyl)propanoic acid, 3-((1,3-dioxo-1,3-dihydroisobenzofuran-5-yl)sulfonyl)propanoic acid, 3-((1,3-dioxo-1,3-dihydroisobenzofuran-5-yl)amino) propanoic acid, 3-((1,3-dioxo-1,3-dihydroisobenzofuran-5-yl)(ethyl)amino)propanoic acid, 3-((3,5-bis(chlorocarbonyl) phenyl)amino) propanoic acid, 3-((3,5-bis(chlorocarbonyl) phenyl)(ethyl)amino) propanoic acid, 4-(4-(chlorocarbonyl)phenyl)-4-oxobutanoic acid, 4-(3,5-bis(chlorocarbonyl)phenyl)-4-oxobutanoic acid, 4-(1,3-dioxo-1,3-dihydroisobenzofuran-5-yl)-4-oxobutanoic acid, 2-(3,5-bis(chlorocarbonyl) phenyl)acetic acid, 2-(2,4-bis(chlorocarbonyl)phenoxy) acetic acid, 4-((3,5-bis(chlorocarbonyl) phenyl)amino)-4-oxobutanoic acid, 2-((3,5-bis(chloro carbonyl)phenyl)amino)acetic acid, 2-(N-(3,5-bis(chlorocarbonyl)phenyl)acetamido)acetic acid, 2,2′-((3,5-bis(chlorocarbonyl)phenylazanediyl) diacetic acid, N-[(1,3-dihydro-1,3-dioxo-5-isobenzofuranyl)carbonyl]-glycine, 4-[[(1,3-dihydro-1,3-dioxo-5-isobenzofuranyl)carbonyl]amino]-benzoic acid, 1,3-dihydro-1,3-dioxo-4-isobenzofuran propanoic acid, 5-[[(1,3-dihydro-1,3-dioxo-5-isobenzofuranyl)carbonyl]amino]-1,3-benzene dicarboxylic acid and 3-[(1,3-dihydro-1,3-dioxo-5-isobenzofuranyl)sulfonyl]-benzoic acid.

Another embodiment is represented by Formula III.

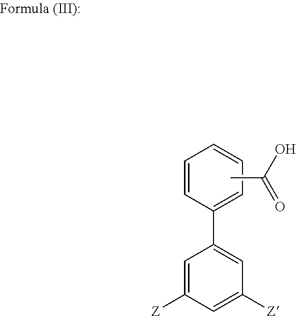

wherein the carboxylic acid group may be located meta, para or ortho upon the phenyl ring.

Representative examples where the hydrocarbon moiety is an aliphatic group are represented by Formula IV.

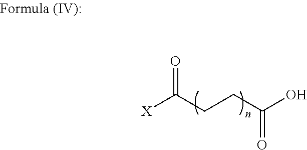

wherein X is a halogen (preferably chlorine) and n is an integer from 1 to 20, preferably 2 to 10. Representative species include: 4-(chlorocarbonyl) butanoic acid, 5-(chlorocarbonyl) pentanoic acid, 6-(chlorocarbonyl) hexanoic acid, 7-(chlorocarbonyl) heptanoic acid, 8-(chlorocarbonyl) octanoic acid, 9-(chlorocarbonyl) nonanoic acid, 10-(chlorocarbonyl) decanoic acid, 11-chloro-11-oxoundecanoic acid, 12-chloro-12-oxododecanoic acid, 3-(chlorocarbonyl)cyclobutanecarboxylic acid, 3-(chlorocarbonyl)cyclopentane carboxylic acid, 2,4-bis(chlorocarbonyl)cyclopentane carboxylic acid, 3,5-bis(chlorocarbonyl) cyclohexanecarboxylic acid, and 4-(chlorocarbonyl) cyclo hexanecarboxylic acid. While the acyl halide and carboxylic acid groups are shown in terminal positions, one or both may be located at alternative positions along the aliphatic chain. While not shown in Formula (IV), the acid-containing monomer may include additional carboxylic acid and acyl halide groups. Representative examples of acid-containing monomers include at least one anhydride group and at least one carboxylic acid groups include: 3,5-bis(((butoxycarbonyl)oxy)carbonyl)benzoic acid, 1,3-dioxo-1,3-dihydroisobenzofuran-5-carboxylic acid, 3-(((butoxycarbonyl)oxy)carbonyl) benzoic acid, and 4-(((butoxycarbonyl)oxy)carbonyl)benzoic acid.

The upper concentration range of acid-containing monomer may be limited by its solubility within the non-polar solution and may be dependent upon whether a tri-hydrocarbyl phosphate compound is also included in the non-polar solution, i.e. the tri-hydrocarbyl phosphate compound is believed to serve as a solubilizer for the acid-containing monomer within the non-polar solvent. In most embodiments, the upper concentration limit is less than 1 wt %. In one set of embodiments, the acid-containing monomer is provided in the non-polar solution at concentration of at least 0.01 wt %, 0.02 wt %, 0.03 wt %, 0.04 wt %, 0.05 wt %, 0.06 wt %, 0.07 wt %, 0.08 wt %, 0.1 wt % or even 0.13 wt % while remaining soluble in solution. In another set of embodiments, the non-polar solution comprises from 0.01 to 1 wt %, 0.02 to 1 wt %, 0.04 to 1 wt % or 0.05 to 1 wt % of the acid-containing monomer. The inclusion of the acid-containing monomer during interfacial polymerization between the polyfunctional amine and acyl halide monomers results in a membrane having improved performance. And, unlike post hydrolysis reactions that may occur on the surface of the thin-film polyamide layer, the inclusion of the acid-containing monomer during interfacial polymerization is believed to result in a polymer structure that is beneficially modified throughout the thin-film layer.

In another embodiment, no such acid-containing monomers are utilized during the preparation of the thin film polyamide layer. As will be described below, in such an embodiment the thin film polyamide layer exhibits unexpected swelling without having a high dissociated carboxylate content.

Once brought into contact with one another, the polyfunctional acyl halide and polyfunctional amine monomers react at their surface interface to form a polyamide layer or film. This layer, often referred to as a polyamide “discriminating layer” or “thin film layer,” provides the composite membrane with its principal means for separating solute (e.g. salts) from solvent (e.g. aqueous feed). The reaction time of the polyfunctional acyl halide and the polyfunctional amine monomer may be less than one second but contact times typically range from about 1 to 60 seconds. The removal of the excess solvent can be achieved by rinsing the membrane with water and then drying at elevated temperatures, e.g. from about 40° C. to about 120° C., although air drying at ambient temperatures may be used.

Swelling of the thin film polyamide layer affects both flux and salt passage and is a measure of the polymer network structure and water solubility of the polyamide layer. For purposes of this invention, an “equilibrium water swelling factor” is measured by a procedure similar to that described in Freger, V., Environ. Sci. Technol. 2004, 38, 3168-3175. In particular, a silicon wafer was wet with a few drops of a 2:1 CH3CN:DMF solvent mixture and the polyamide composite membrane was pressed against the wafer surface such that the polyamide layer faced the wafer. Following drying the wafer and the composite membrane under vacuum for 20 minutes at 70° C., methylene chloride was successively applied to the membrane to delaminate the non-woven backing and dissolve the polysulfone support. The polyamide/silicon system was further dried under vacuum. To obtain a film height, the 50 to 100 micron area was removed using the contact mode of the AFM. Probes with a spring constant of ˜40 M/m were used. This method has significant advantages over scratching the membrane in that it provide a height measurement from the identical area from the ambiet and hydrated areas, provided little edge tearing and significantly reduce the chances of delamination. For both the ambiet dry sample and the same membrane soaked in DI water overnight, a Peak Force Tapping Atomic Force Microscopy (PFT-AFM) was used to scan (peak force engage setpoint of 0.15 V and a peak force set point of 1 V with a scan angle of 0° and a scan rate of 1.6 Hz) across different locations of the membrane. Probes with a spring constant of 3-5 N/m were used with peak force amplitude of 300 nm and peak force frequency of 2 KHz. The polyamide water swelling factor is the average increase in thickness between the initial dry measurements and subsequent wet measurements divided by the average value of initial dry thickness measurement. A preferred equilibrium water swelling factor for the polyamide is equal to or greater than 35%, 40%, 45%, 50%, 60% or even greater than 65% (e.g. 35 to 70%). In a preferred embodiment, the equilibrium water swelling factor is less than 75%

In one set of embodiments, the thin film polyamide layer is characterized by having a dissociated carboxylate content of less than 0.18 moles/kg, 0.16 moles/kg, and in some embodiments, less than 0.15 moles/kg of polyamide. In such an embodiment the thin film polyamide layer exhibits unexpected swelling without having a high dissociated carboxylate content. In another set of embodiments, the thin film polyamide layer is characterized by having a dissociated carboxylate content of least 0.4 moles/kg (e.g. 0.4 to 0.5 moles/kg) and in some embodiments at least 0.45 moles/kg of polyamide In each case, the dissociated carboxylate content is measured at pH 9.5 using Rutherford Backscattering (RBS). More specifically, samples membranes (1 inch×6 inch) are boiled for 30 minutes in deionized water (800 mL), then placed in a 50/50 w/w solution of methanol and water (800 mL) to soak overnight. Next, 1 inch×1 inch size sample of these membranes are immersed in a 20 mL 1 ×10⁻⁴ M AgNO₃ solution with pH adjusted to 9.5 for 30 minutes. Vessels containing silver ions are wrapped in tape and to limit light exposure. After soaking with the silver ion solution, the unbound silver is removed by soaking the membranes in 2 clean 20 mL aliquots of dry methanol for 5 minutes each. Finally, the membranes are allowed to dry in a nitrogen atmosphere for a minimum of 30 minutes. Membrane samples are mounted on a thermally and electrically conductive double sided tape, which was in turn mounted to a silicon wafer acting as a heat sink The tape is preferably Chromerics Thermattach T410 or a 3M copper tape. RBS measurements are obtained with a Van de Graff accelerator (High Voltage Engineering Corp., Burlington, Mass.); A 2 MeV He room temperature beam with a diameter of 3 mm at an incident angle of 22.5°, exit angle of 52.5°, scattering angle of 150°, and 40 nanoamps (nAmps) beam current. Membrane samples are mounted onto a movable sample stage which is continually moved during measurements. This movement allows ion fluence to remain under 3×10¹⁴ He⁺/cm². Analysis of the spectra obtained from RBS is carried out using SIMNRA®, a commercially available simulation program. A description of its use to derive the elemental composition from RBS analysis of RO/NF membranes is described by; Coronell, et. al. J. of Membrane Sci. 2006, 282, 71-81 and Environmental Science & Technology 2008, 42(14), 5260-5266. Data can be obtained using the SIMNRA® simulation program to fit a two layer system, a thick polysulfone layer beneath a thin polyamide layer, and fitting a three-layer system (polysulfone, polyamide, and surface coating) can use the same approach. The atom fraction composition of the two layers (polysulfone before adding the polyamide layer, and the surface of final TFC polyamide layer) is measured first by XPS to provide bounds to the fit values. As XPS cannot measure hydrogen, an H/C ratio from the proposed molecular formulas of the polymers were used, 0.667 for polysulfone and a range of 0.60-0.67 was used for polyamide Although the polyamides titrated with silver nitrate only introduces a small amount of silver, the scattering cross section for silver is substantially higher than the other low atomic number elements (C, H, N, O, S) and the size of the peak is disproportionately large to the others despite being present at much lower concentration thus providing good sensitivity. The concentration of silver is determined using the two layer modeling approach in SIMNRA® by fixing the composition of the polysulfone and fitting the silver peak while maintaining a narrow window of composition for the polyamide layer (layer 2, ranges predetermined using XPS). From the simulation, a molar concentration for the elements in the polyamide layer (carbon, hydrogen, nitrogen, oxygen and silver) is determined The silver concentration is a direct reflection of the carboxylate molar concentration available for binding silver at the pH of the testing conditions. The moles of carboxylic acids groups per unit area of membrane is indicative of the number of interactions seen by a species passing through the membrane, and a larger number will thus favorably impact salt passage. This value may be calculated by multiplying the measured carboxylate content by a measured thickness and by the polyamide density. Alternatively, the carboxylate number per unit area of membrane (moles/m2) may be determined more directly by methods that measure the total complexed metal within a known area. Approaches using both Uranyl acetate and toluidine blue O dye are described in: Tiraferri, et. al., Journal of Membrane Science, 2012, 389, 499-508. An approach to determine the complexed cation (sodium or potassium) content in membranes by polymer ashing is described in (Wei Xie, et al., Polymer, Volume 53, Issue 7, 22 Mar. 2012, Pages 1581-1592). A preferred method to determine the dissocated carboxylate number at pH 9.5 per unit area of membrane for a thin film polyamide membrane is as follows. A membrane sample is boiled for 30 minutes in deionized water, then placed in a 50 wt % solution of methanol in water to soak overnight. Next, the membrane sample is immersed in a 1×10⁻⁴ M AgNO₃ solution with pH adjusted to 9.5 with NaOH for 30 minutes. After soaking in the silver ion solution, the unbound silver is removed by soaking the membranes twice in dry methanol for 30 minutes. The amount of silver per unit area is preferably determined by ashing, as described by Wei, and redissolving for measurement by ICP.

In another preferred embodiment, MS response of the thin film polyamide layer at 650° C. results in a ratio of responses from a flame ionization detector for fragments produced at 212 m/z and 237 m/z of equal to or less than 1.90% (i.e. ratio of dimers produced at 212 m/z to those produced at 237 m/z. The fragments produced at 212 and 237 m/z are represented by Formula V and VI, respectively.

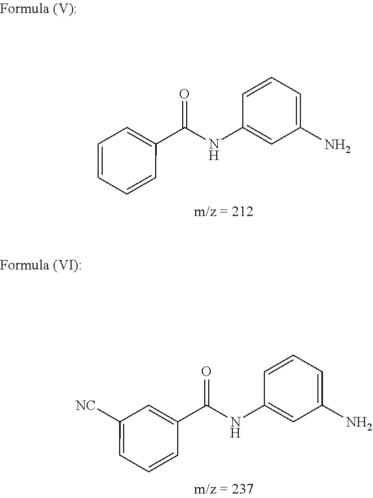 [SMILES: Nc1cccc(NC(=O)c2ccccc2)c1 ; N#Cc1cccc(C(=O)Nc2cccc(N)c2)c1]

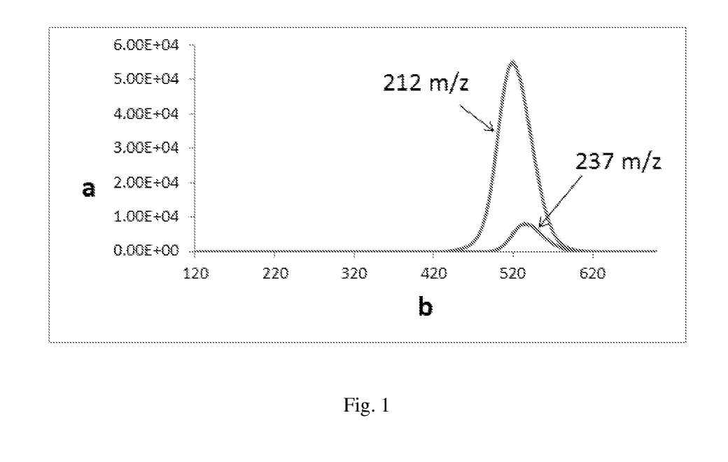

The ratio of fragments (Formula V:Formula VI) is believed to be indicative of polymer structures that provide improved flux, With reference to FIG. 1, investigation has shown that the dimer fragment at 212 m/z forms predominantly during pyrolysis temperatures below 500° C. whereas the dimer fragment 237 m/z predominantly forms at pyrolysis temperatures above 500° C. This indicates that dimer fragment 212 originates from end groups where only single bound cleavage prevails and that dimer fragment 237 originates substantially from the bulk material where multiple bond cleavages and reduction occurs. Thus, the ratio of dimer fragment 212 m/z to that at 237 m/z can be used as a measure of relative conversion. Said another way, larger dimer ratios (212 m/z:237 m/z) are indicative of a less brandied network structure which is theorized to provide less morphological barriers to transport and hence greater flux. A preferred pyrolysis methodology is conducted using gas chromatography mass spectrometry with mass spectral detection, e.g. a Frontier Lab 2020iD pyrolyzer mounted on an Agilent 7890 GC with detection using a LECO time of flight (TruTOF) mass spectrometer. Peak area detection is made using a flame ionization detector (FID). Pyrolysis is conducted by dropping the polyamide sample cup into pyrolysis oven set at 650° C. for 6 seconds in single shot mode. Separation is performed using a 30M×0.25 mm id column from Varian (FactorFour VF-5MS CP8946) with a 1 um 5% phenyl methyl silicone internal phase. Component identification is made by matching the relative retention times of the fragment peaks to that of the same analysis performed with a LECO time of flight mass spectrometer (or optionally by matching mass spectra to a NIST database or references from literature). Membrane samples are weighed into Frontier Labs silica lined stainless steel cups using a Mettler E20 micro-balance capable of measuring to 0.001 mg. Sample weight targets were 200 ug+/−50 ug. Gas chromatograph conditions are as follows: Agilent 6890 GC (SN: CN10605069), with a 30M×0.25 mm, 1 μm 5% dimethyl polysiloxane phase (Varian FactorFour VF-5MS CP8946); injection port 320° C., Detector port: 320° C., Split injector flow ratio of 50:1, GC Oven conditions: 40° C. to 100° C. at 6° C. per min., 100° C. to 320° C. at 30° C./min, 320° C. for 8 min; Helium carrier gas with constant flow of 0.6 mL/min providing a back pressure of 5.0 psi. LECO TruTOF Mass Spectrometer Parameters are as follows: electron ionization source (positive EI mode), Scan Rate of 20 scans per second, Scan range: 14-400 m/z; Detector voltage=3200 (400V above tune voltage); MS acquisition delay=1 min; Emission Voltage—70V. The peak area of the fragment 212 m/z and fragment 237 m/z are normalized to the sample weight. The normalized peak areas are used to determine the ratio of fragments 212 m/z to 237 m/z. Further the normalize peak area of fragment 212 m/z is divided by the sum of the normalized peak areas for all other fragments providing a fraction of the m/z 212 fragment relative to the polyamide and is commonly noted as a percent composition by multiplying by 100. This methodology was used to determine the dimer content reported for the samples in the Example section. Preferably this value is equal to or less than 1.90%, 1.80%, 1.75%, 1.70%, and in some embodiments even less 1.60%. Preferred ranges include: 1.0% to 1.9%, 1.3% to 1.80%, 1.4% to 1.75 and 1.50% to 1.60%.

The thin film polyamide layer may optionally include hygroscopic polymers upon at least a portion of its surface. Such polymers include polymeric surfactants, polyacrylic acid, polyvinyl acetate, polyalkylene oxide compounds, poly(oxazoline) compounds, polyacrylamides and related reaction products as generally described in U.S. Pat. No. 6,280,853; U.S. Pat No. 7,815,987; U.S. Pat. No. 7,918,349 and U.S. Pat. No. 7,905,361. In some embodiments, such polymers may be blended and/or reacted and may be coated or otherwise applied to the polyamide membrane from a common solution, or applied sequentially.

Many embodiments of the invention have been described and in some instances certain embodiments, selections, ranges, constituents, or other features have been characterized as being “preferred.” Characterizations of “preferred” features should in no way be interpreted as deeming such features as being required, essential or critical to the invention.

### EXAMPLES

### Example 1

Sample membranes were prepared using a pilot scale membrane manufacturing line. Polysulfone supports were casts from 16.5 wt % solutions in dimethylformamide (DMF) and subsequently soaked in a 3.5 wt % aqueous solution meta-phenylene diamine (mPD) including various quantities of tri ethyl phosphate (TEP) as designated below in Table 1, or tri propyl phosphate (TPP) as indicated in Table 2. The resulting support was then pulled through a reaction table at constant speed while a thin, uniform layer of a non-polar coating solution was applied. The non-polar coating solution included a isoparaffinic solvent (ISOPAR L) and 0.20 wt/vol% trimesoyl acid chloride (TMC). Excess non-polar solution was removed and the resulting composite membrane was passed through water rinse tanks and drying ovens. Sample membrane sheets were tested using a 2000 ppm NaCl solution at 25° C., pH 8 and 225 psi. Equilibrium water swelling factors, dimer, etc. were measured according to the techniques previously described.

TABLE 1

| | | | | | | Dissociated |
|---|---|---|---|---|---|---|
| | | | Mean NaCl | Equilibrium | | carboxylate |
| | TEP | Mean Avg Flux | Passage | water swelling | Dimer | content |
| Sample | (wt %) | (GFD)/(st. dev.) | (%)/(st. dev.) | factor (%) | Ratio | (mmoles/g) |
| 1-1 | 0 | 24.14 (0.69) | 0.594 (N/A) | 11 | 1.92 | 0.13 |
| 1-2 | 0.03 | 29.69 (1.24) | 0.498 (0.032) | 4 | 1.97 | 0.18 |
| 1-3 | 0.10 | 33.94 (0.34) | 0.471 (0.013) | 2 | 1.74 | 0.12 |
| 1-4 | 0.3 | 50.64 (0.90) | 0.451 (0.034) | 65 | 1.71 | 0.12 |
| 1-5 | 0.50 | 48.31 (1.75) | 0.374 (0.010) | 42 | 1.54 | 0.13 |
| 1-6 | 0.75 | 50.96 (1.52) | 0.412 (0.005) | 45 | 1.59 | 0.12 |
| 1-7 | 1.00 | 47.56 (1.23) | 0.468 (0.039) | 70 | 1.51 | 0.14 |
| 1-8 | 2 | 26.65 (0.91) | 1.226 (0.027) | 53 | 1.97 | 0.12 |

TABLE 2

| | | | Mean NaCl |
|---|---|---|---|
| | TPP | Mean Avg Flux | Passage |
| Sample | (wt %) | (GFD)/(st. dev.) | (%)/(st. dev) |
| 2-1 | 0 | 21.16 (2.29) | 0.74 (0.05) |
| 2-2 | 0.05 | 25.33 (2.19) | 0.62 (0.05) |
| 2-3 | 0.1 | 31.93 (1.96) | 0.51 (0.04) |
| 2-4 | 0.3 | 38.83 (1.08) | 0.43 (0.04) |
| 2-5 | 0.45 | 42.56 (1.23) | 0.40 (0.02) |

### Comparison Example 2

Sample membranes were prepared and tested in the same manner as Example 1 except that TEP was combined with the non-polar solution rather than the polar solution. More specifically, the non-polar coating solution included a isoparaffinic solvent (ISOPAR L) and 0.20 wt/vol% trimesoyl acid chloride (TMC) including various quantities of tri ethyl phosphate (TEP) as designated below in Table 3. As evident from the testing results, membrane performance was significantly low when TEP was added from non-polar phase as compared with the polar phase.

TABLE 3

| | | | | | | | | Dissociated |
|---|---|---|---|---|---|---|---|---|
| | | | | Mean NaCl | | Equilibrium | | carboxylate |
| | TEP | Mean Avg Flux | | Passage | | water swelling | Dimer | content |
| Sample | (wt %) | (GFD)/(st. dev.) | | (%)/(st. dev.) | | factor (%) | Ratio | (mmoles/g) |
| 3-1 | 0 | 9.01 | (0.98) | 1.79 | (0.35) | NA | 2.3 | 0.11 |
| 3-2 | 0.03 | 13.29 | (0.13) | 31.9 | (4.6) | 8.73 | 2.3 | 0.09 |
| 3-3 | 0.1 | 13.48 | (2.35) | 37.6 | (19.4) | 18.43 | 1.5 | 0.09 |
| 3-4 | 0.2 | 21.13 | (5.89) | 65.8 | (7.9) | 25.97 | 1.1 | 0.12 |
| 3-5 | 0.3 | 18.01 | (4.66) | 56.3 | (9.7) | 12.77 | 1.2 | 0.09 |
| 3-6 | 0.5 | 12.18 | (1.58) | 48.0 | (4.5) | NA | 1.4 | 0.09 |
| 3-7 | 0.6 | 23.58 | (1.53) | 57.5 | (4.7) | NA | 1.5 | 0.12 |

1. A method for making a composite polyamide membrane comprising a porous support and a thin film polyamide layer, wherein the method comprises applying a polar solution comprising a polyfunctional amine monomer and a non-polar solution comprising a polyfunctional acyl halide monomer to a surface of a porous support and interfacially polymerizing the monomers to form a thin film polyamide layer,
wherein the method is characterized by the polar solution further comprising a tri-hydrocarbyl phosphate compound represented by Formula I: 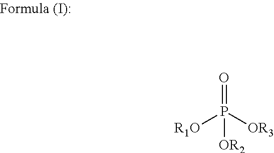
wherein R₁, R₂ and R₃ are independently selected from hydrogen and hydrocarbyl groups comprising from 1 to 3 carbon atoms, with the proviso that no more than one of R₁, R₂ and R₃ are hydrogen, and
wherein the thin film polyamide layer is characterized by possessing an equilibrium water swelling factor of greater than 35% as measured by PFT-AFM.

2. The method of claim 1 wherein the thin film polyamide layer is characterized by possessing an equilibrium water swelling factor of greater than 45%.

3. The method of claim 1 wherein the thin film polyamide layer is characterized by possessing an equilibrium water swelling factor of 35 to 70%.

3. (canceled)

4. The method of claim 1 wherein the thin film polyamide layer has a dissociated carboxylic acid content of less than 0.18 moles/kg at pH 9.5 as measured by RBS.

5. The method of claim 1 wherein the thin film polyamide layer has a dissociated carboxylic acid content of less than 0.16 moles/kg at pH 9.5 as measured by RBS.

6. The method of claim 1 wherein the thin film polyamide layer is further characterized by producing a ratio of dimers represented by Formula V and VI equal to or less than 1.90% upon pyrolysis at 650° C. as measured by MS.

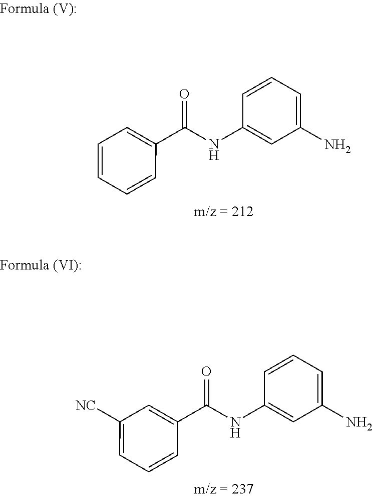 [SMILES: Nc1cccc(NC(=O)c2ccccc2)c1 ; N#Cc1cccc(C(=O)Nc2cccc(N)c2)c1]

7. The method of claim 6 wherein the thin film polyamide layer is further characterized by producing a ratio the dimers of from 1.30% to 1.80%.

8. The method of claim 1 wherein the tri-hydrocarbyl phosphate compound comprises triethylphosphate.

9. The method of claim 8 wherein the polar solution comprises from 0.3 to 2 wt % of triethylphosphate.

10. The method of claim 1 wherein the non-polar solution further comprises an acid-containing monomer comprising a C₂-C₂₀ hydrocarbon moiety substituted with at least one carboxylic acid functional group or salt thereof and at least one amine-reactive functional group selected from: acyl halide, sulfonyl halide and anhydride, wherein the acid-containing monomer is distinct from the polyfunctional acyl halide monomer.

11. The method of claim 10 wherein the thin film polyamide layer is further characterized by possessing a dissociated carboxylate content of at least 0.2 mol/kg.

12. The method of claim 10 wherein the thin film polyamide layer is further characterized by possessing a dissociated carboxylate content of at least 0.40 mol/kg.
